(19) United States
(12) Patent Application Publication
(10) Pub. No.: US 2018/0052838 A1
(43) Pub. Date: Feb. 22, 2018

(54) SYSTEM, METHOD AND COMPUTER PROGRAM FOR A COGNITIVE MEDIA STORY EXTRACTOR AND VIDEO COMPOSER

(71) Applicant: International Business Machines Corporation, Armonk, NY (US)

(72) Inventors: Alessio BONTI, Melbourne (AU); Lianhua Chi, Melbourne (AU)

(21) Appl. No.: 15/243,731

(22) Filed: Aug. 22, 2016

(51) Int. Cl. G06F 17/30; G06F 17/27

(52) U.S. Cl. CPC G06F 17/30026; G06F 17/30035; G06F 17/30038; G06F 17/3005; G06F 17/2785; G06F 17/3084; G06F 17/30817; G06F 17/30867; G06F 17/30828

(57) ABSTRACT

A story board creating computer-implemented method, system, and computer program product, includes preprocessing contextual information to obtain story content, extracting story extractions based on the story content and input metadata by a user, creating a story pool including a plurality of story items by querying a database with the story extractions, and creating a story board from the story items of the story pool based on a story relevance to the story content and a personality distance between the story board and a target audience.

### BACKGROUND

The present invention relates generally to a story board creating method, and more particularly, but not by way of limitation, to a system, method, and recording medium for querying a database for a plurality of story items (e.g., media segments) to create a story board from a base story.

Creating videos, which are aimed at particular subjects and that are closely related to a particular story or topic takes time and experience. Such experience is built over the years by people working in the industry.

For example, a news organization requires a large staff to find segments to piece together in order to form a story board for the news to air and discuss.

There is a need in the art to automate a video creation process and augment the video to reduce cost associating with staffing and time required to compile the video segments.

### SUMMARY

In an exemplary embodiment, the present invention can provide a computer-implemented story board creating method, the method including preprocessing contextual information to obtain story content, extracting story extractions based on the story content and input metadata by a user, creating a story pool including a plurality of story items by querying a database with the story extractions, and creating a story board from the story items of the story pool based on a story relevance to the story content and a personality distance between the story board and a target audience.

Further, in another exemplary embodiment, the present invention can provide a computer program product for story board creating, the computer program product comprising a computer-readable storage medium having program instructions embodied therewith, the program instructions executable by a device to cause the device to perform: preprocessing contextual information to obtain story content, extracting story extractions based on the story content and input metadata by a user, creating a story pool including a plurality of story items by querying a database with the story extractions, and creating a story board from the story items of the story pool based on a story relevance to the story content and a personality distance between the story board and a target audience.

Even further, in another exemplary embodiment, the present invention can provide a story board creating system, said system including a processor, and a memory, the memory storing instructions to cause the processor to: preprocess contextual information to obtain story content, extract story extractions based on the story content and input metadata by a user, create a story pool including a plurality of story items by querying a database with the story extractions, and create a story board from the story items of the story pool based on a story relevance to the story content and a personality distance between the story board and a target audience.

There has thus been outlined, rather broadly, an embodiment of the invention in order that the detailed description thereof herein may be better understood, and in order that the present contribution to the art may be better appreciated. There are, of course, additional exemplary embodiments of the invention that will be described below and which will form the subject matter of the claims appended hereto.

It is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The exemplary aspects of the invention will be better understood from the following detailed description of the exemplary embodiments of the invention with reference to the drawings:

FIG. 1 depicts a high-level flow chart for a story board creating method 100 according to an embodiment of the present invention;

FIG. 2 depicts a cloud computing node 10 according to an embodiment of the present invention;

FIG. 3 depicts a cloud computing environment 50 according to an embodiment of the present invention;

FIG. 4 depicts abstraction model layers according to an embodiment of the present invention.

### DETAILED DESCRIPTION

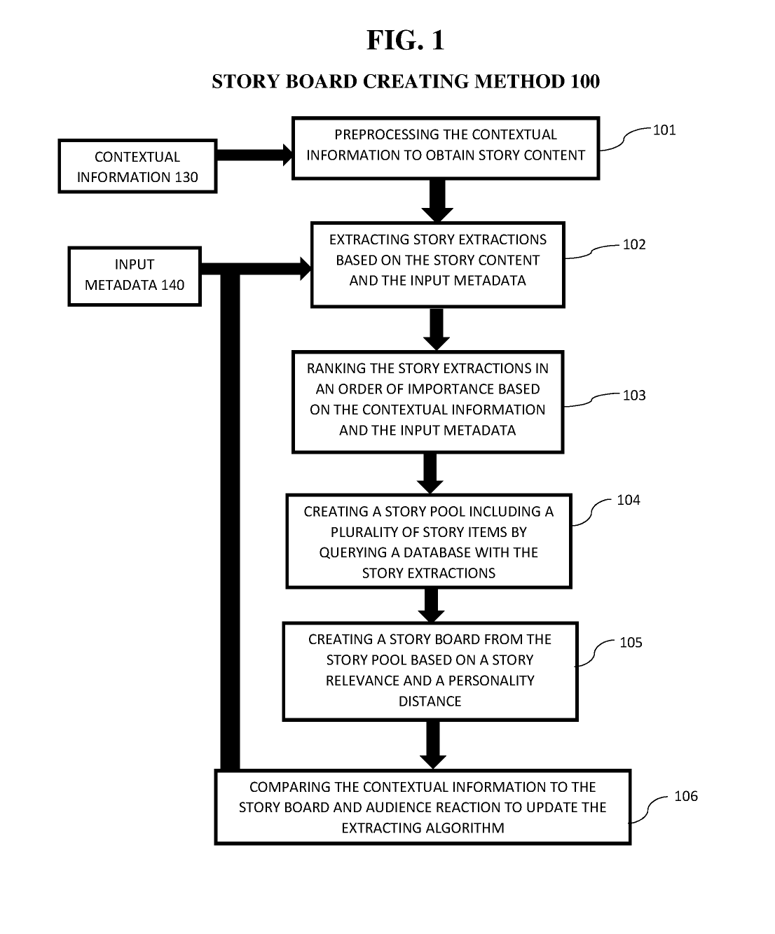

The invention will now be described with reference to FIGS. 1-4, in which like reference numerals refer to like parts throughout. It is emphasized that, according to common practice, the various features of the drawing are not necessarily to scale. On the contrary, the dimensions of the various features can be arbitrarily expanded or reduced for clarity. Exemplary embodiments are provided below for illustration purposes and do not limit the claims.

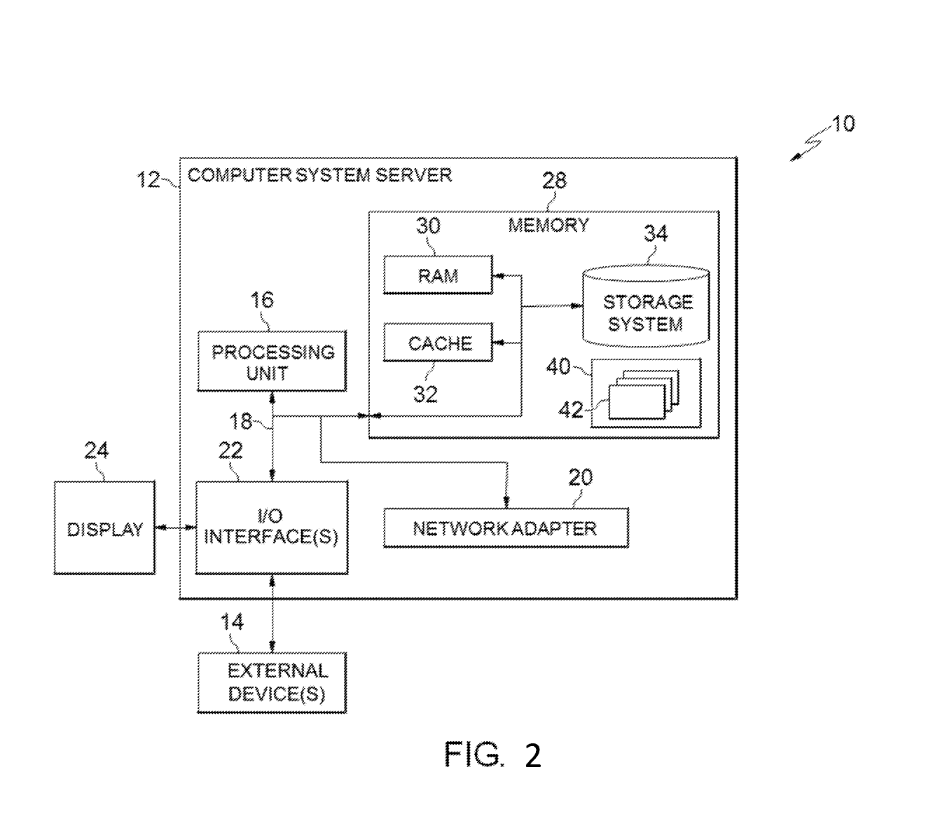

With reference now to FIG. 1, a story board creating method 100 according to an embodiment of the present invention includes various steps to facilitate a selection of story items which are not only relevant, but also positively resonates with a target audience. As shown in at least FIG. 2, one or more computers of a computer system 12 according to an embodiment of the present invention may include a memory 28 having instructions stored in a storage system to perform the steps of FIG. 1.

Thus, a story board creating method 100 according to an embodiment of the present invention may act in a more sophisticated and useful fashion, and in a cognitive manner while giving the impression of cognitive mental abilities and processes related to knowledge, attention, memory, judgment and evaluation, reasoning, and advanced computation. That is, a system is said to be “cognitive” if it possesses macro-scale properties—perception, goal-oriented behavior, learning/memory and action—that characterize systems (i.e., humans) that are generally agreed as cognitive.

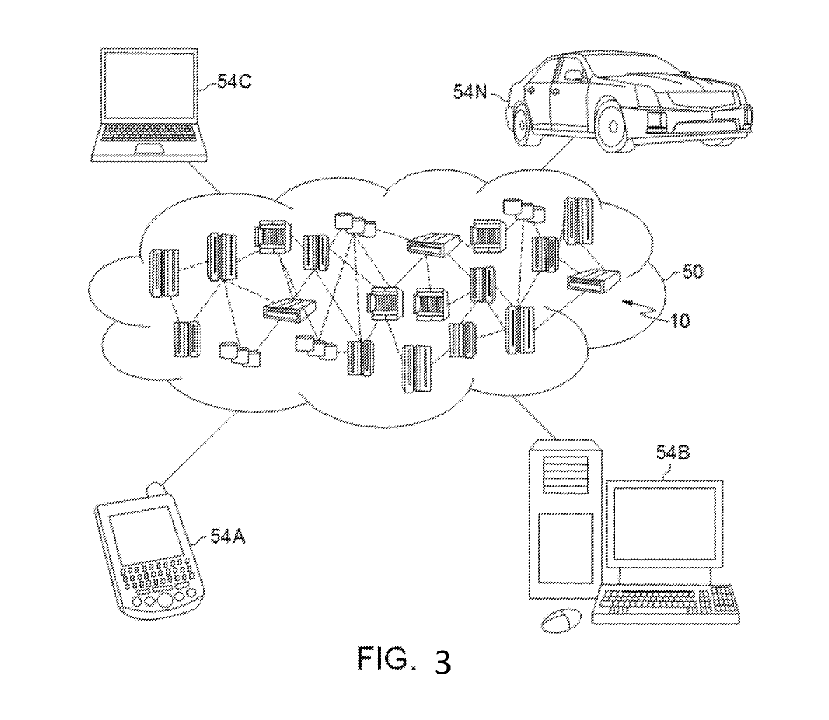

As will described/illustrated herein, one or more embodiments of the present invention (see e.g., FIGS. 2-4) may be implemented in a cloud environment 50 (see e.g., FIG. 3). It is nonetheless understood that the present invention can be implemented outside of the cloud environment.

Referring now to FIG. 1, in step 101, contextual information 130 is preprocessed to obtain story content. In some embodiments, the contextual information (e.g., information of a base story) may include locations, sentiment, relevance, a topic, etc. of different types of media comprising videos, text, music, etc. Thus, the base story (and format thereof) may be a word, a sentence, a photograph, music, a movie, etc.). The story content may include textual information, video information, an audio file and imagery information processed into a text file via the preprocessing in step 101 which describes the contextual information 130. In other words, the contextual information 130 comprises a story input about which is desired to have a related video compiled. The contextual information 130 from the media content is preprocessed and transformed into textual information based on a corpus of data and rules. In this manner, the preprocessing can be “smarter” (e.g., via machine learning) over time. It is noted that the corpus comprises information, built over time, which may include a collection of textual information, video, music, images and more. The corpus is able to grow over time, as more requests are made, and as more data is fed into it.

In one embodiment, for example, the contextual information 130 may include a video of a celebration of Independence Day (e.g., a base story) about which a user would like to create a news story. In step 101, the video of the celebration of Independence Day is preprocessed to transform the video into a textual description (e.g., story content). For example, the story content for the video of the celebration of Independence Day may be obtained in step 101 and includes a location of the celebration, positive atmosphere surrounding the celebration, topics such as fireworks, picnics, traffic, etc.

In step 102, story extractions are extracted based on the story content from step 101 and input metadata 140. The input metadata 140 comprises additional information that can be provided in order to augment the story creation. The input metadata 140 may include, for example, a target audience (e.g., based on typical demographic watching the news segment or for marketing reasons), a target location, a time, an objective (e.g., such as being informative versus being entertaining) and other supportive material such as information not corpus included material.

Story extractions may include actionable queries for querying a database with the actionable queries to find similar (related) content (as described later). For example, a natural language processor (NLP) can extract information from the story content of step 101 in step 102. By using the NLP on the text file for the story content, story extractions (e.g., actionable queries of a corpus/database) can be extracted in step 102 and may include a location of story content, actions performed in the story content (e.g., “a boy is running”, “fireworks are exploding”, “people are eating hot dogs”, etc.), emotional inferences (e.g., “people are happy”, “people are sad”, etc.), people to search for (e.g., travelers, a sick person, etc.) items in the story content, etc. The story extractions can be based on both the story content (e.g., the contextual information 130) and the input metadata 140 such that the user can further control the type of story extractions to search the database with (e.g., use the input metadata 140 to limit the story extractions to content which is safe for viewing by children).

That is, story extractions extracted in step 102 from the story content and the input metadata 140 control a type of story item (e.g., media content) that the method 100 will use to create the story board (as described later).

In step 103, the story extractions are ranked in an order of importance based on the contextual information 130 and the input metadata 140. In some embodiments, the story content can be weighted to determine the type of story item most desirable to return such as, although the story content included a time of day with the Independence Day video, a location of the story content can be weighted more than the time of day. Similarly, in other embodiments, the input metadata 140 can be used to rank the story extractions such as limiting the actionable queries only to relate to age appropriate content.

In step 104, a story pool including a plurality of story items is created by querying a database (corpus) with the story extractions. The plurality of story items comprise different media items such as a video segment, an audio file, an image, etc. related to the story extractions. For example, if a story extraction is “fireworks”, a video segment of fireworks or a patriotic image may be returned as a story item to include the story pool. In other words, the story pool comprises a plurality of items to choose from to form a story board (as described later).

In step 104, a corpus and/or external database is queried for more information for each of the story extractions, and the returns of the queries are used to create a story pool. The story extractions may include queries, which can find appropriate video footage, appropriate images, music and further information. In some embodiments, a story, which describes a lunch in Tuscany, will go looking for footage of Tuscan villas, traditional food images and videos, peaceful music, etc.

In some embodiments, the input metadata 140 can be used further augment the story extractions if the results from the query are not desirable. For example, a particular target audience will return a subset of the previous footage acquired or find more footage. That is, a focused story extraction towards target audience can be executed to query the database for story items that must satisfy the target audience condition.

In step 105, a story board is created from the plurality of items of the story pool based on a story relevance and a personality distance between the story pool item and the target audience.

In some embodiments, the story relevance may include the accuracy that the selected story item and the overall story board accurately represent the original story (e.g., contextual information 130 and the input metadata 140) and deliver adequate content. In order to evaluate the accuracy, the NLP in step 102 may be used to verify that the correlation between the base story and the story board is still relevant.

In some embodiments, the personality distance comprises how well a target audience receives the story board and a cognitive technique can be used to evaluate whether the story board resonates positively (e.g., through user feedback, ratings data, sensor data, social media, etc.) with the target audience.

In step 106, the contextual information is compared to the story board and target audience to update the algorithm in step 102 to extract story extracts. That is, the method 100 is able to act in a cognitive manner and get “smarter” over time as the corpus is updated and story extractions are refined to obtain accurate story items.

Thereby, the method 100 may solve at least three of many issues in the art by creating a story board based on the information provided and, optionally, using the target audience, finding relevant resources to create the video, and compose the video. In other words, the method 100 includes a technical solution by steps 101-106 to solve the technical problem in the art of automating a video creation process and augmenting the video to reduce cost associating with staffing and time required to compile the video segments.

In some embodiments, in step 104, the created story pool including the plurality of story items can be displayed on a Graphical User Interface (GUI) including a selectable portion for each of the story items in the story pool such that a user can select which story items to create the story board in step 105 with. That is, the user can be displayed a plurality of story items and using the GUI, the user can decide which story items are most relevant to the story board. In step 106, the GUI selections can be used to update the contextual information such that the selection process is improved over time.

Exemplary Hardware Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 2, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring again to FIG. 2, computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external circuits 14 such as a keyboard, a pointing circuit, a display 24, etc.; one or more circuits that enable a user to interact with computer system/server 12; and/or any circuits (e.g., network card, modem, etc.) that enable computer system/server 12 to communicate with one or more other computing circuits. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

Referring now to FIG. 3, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 3 are intended to be illustrative only and that computing nodes 10 and cloud computing environment 50 can communicate with any type of computerized circuit over any type of network and/or network addressable connection (e.g., using a web browser).

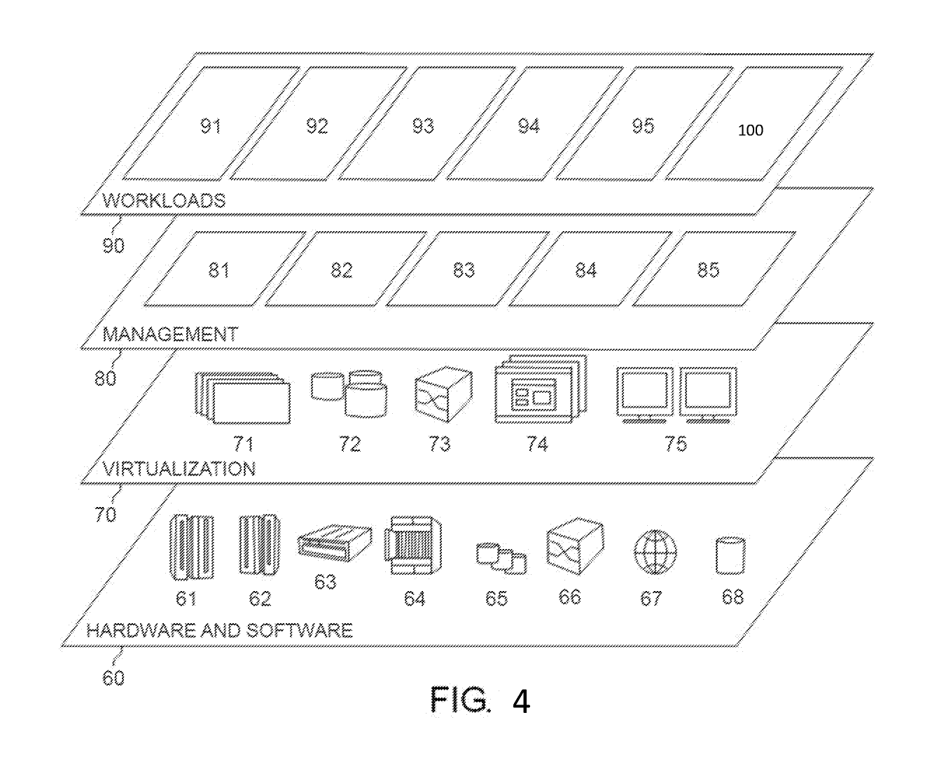

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, more particularly relative to the present invention, the story board creating method 100.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented story board creating method, the method comprising:
preprocessing contextual information to obtain story content;
extracting story extractions based on the story content and input metadata by a user;
creating a story pool including a plurality of story items by querying a database with the story extractions; and
creating a story board from the story items of the story pool based on a story relevance to the story content and a personality distance between the story board and a target audience.

2. The computer-implemented method of claim 1, wherein the contextual information is selected from a group consisting of:
a location of the contextual information;
a sentiment of the contextual information; and
a topic of the contextual information.

3. The computer-implemented method of claim 1, wherein a format of the contextual information is selected from a group consisting of:
a video;
a text file; and
an audio file.

4. The computer-implemented method of claim 1, wherein the story content comprises a textual description of the contextual information.

5. The computer-implemented method of claim 1, wherein the story extractions comprise actionable queries with which the creating queries the database to receive related story items to the contextual information and the input metadata.

6. The computer-implemented method of claim 1, further comprising ranking the story extractions in an order of importance based on a weighted value of the contextual information and a weighted value of the input metadata.

7. The computer-implemented method of claim 1, wherein the story relevance comprises an accuracy that the selected story items for the story board correspond to the contextual information and the metadata, and
wherein the accuracy is determined by a natural language processor determining a similarity between the selected story items for the story board to the contextual information and the metadata.

8. The computer-implemented method of claim 1, wherein the personality distance comprises a semantic difference between the story items of the story board and the target audience input with the metadata by the user.

9. The computer-implemented method of claim 1, further comprising comparing the contextual information to the story board and the target audience reaction to update an extracting algorithm used by the extracting to extract the story extractions comprising a greater story relevance and a smaller personality distance.

10. The computer-implemented method of claim 1, embodied in a cloud-computing environment.

11. A computer program product for story board creating, the computer program product comprising a computer-readable storage medium having program instructions embodied therewith, the program instructions executable by a device to cause the device to perform:
preprocessing contextual information to obtain story content;
extracting story extractions based on the story content and input metadata by a user;
creating a story pool including a plurality of story items by querying a database with the story extractions; and
creating a story board from the story items of the story pool based on a story relevance to the story content and a personality distance between the story board and a target audience.

12. The computer program product for story board creating of claim 11, wherein the contextual information is selected from a group consisting of:
a location of the contextual information;
a sentiment of the contextual information; and
a topic of the contextual information.

13. The computer program product for story board creating of claim 11, wherein a format of the contextual information is selected from a group consisting of:
a video;
a text file; and
an audio file.

14. The computer program product for story board creating of claim 11, wherein the story content comprises a textual description of the contextual information.

15. The computer program product for story board creating of claim 11, wherein the story extractions comprise actionable queries with which the creating queries the database to receive related story items to the contextual information and the input metadata.

16. The computer program product for story board creating of claim 11, further comprising ranking the story extractions in an order of importance based on a weighted value of the contextual information and a weighted value of the input metadata.

17. A story board creating system, said system comprising:
a processor; and
a memory, the memory storing instructions to cause the processor to:
preprocess contextual information to obtain story content;
extract story extractions based on the story content and input metadata by a user;
create a story pool including a plurality of story items by querying a database with the story extractions; and
create a story board from the story items of the story pool based on a story relevance to the story content and a personality distance between the story board and a target audience.

18. The system of claim 17, wherein the story content comprises a textual description of the contextual information.

19. The system of claim 17, wherein the story extractions comprise actionable queries with which the creating queries the database to receive related story items to the contextual information and the input metadata.

20. The system of claim 17, embodied in a cloud-computing environment.
